(19) United States
(12) Patent Application Publication
(10) Pub. No.: US 2026/0202512 A1
(43) Pub. Date: Jul. 16, 2026

(54) SOILING ESTIMATION DEVICE, SOILING ESTIMATION METHOD, AND STORAGE MEDIUM

(71) Applicant: TOYOTA JIDOSHA KABUSHIKI KAISHA, Toyota-shi (JP)

(72) Inventors: Ryusuke UMEYAMA, Susono-shi (JP); Shoichi HAYASAKA, Atsugi-shi (JP)

(73) Assignee: TOYOTA JIDOSHA KABUSHIKI KAISHA, Toyota-shi (JP)

(21) Appl. No.: 19/402,170

(22) Filed: Nov. 26, 2025

(30) Foreign Application Priority Data
Jan. 16, 2025 (JP) 2025-006129

(51) Int. Cl. G01S 7/40; G01S 7/41; G01S 13/931

(52) U.S. Cl. CPC G01S 7/4039; G01S 7/411; G01S 13/931; G01S 2013/9318; G01S 2013/93185

(57) ABSTRACT

The soiling estimation device includes an acquisition unit that acquires information on a target existing in front of a vehicle detected by a millimeter-wave radar mounted on the vehicle, a determining unit that determines whether the target indicated by the information acquired by the acquisition unit is a road surface reflection target corresponding to an unevenness of a road surface in front of the vehicle that has reflected the radio waves emitted from the millimeter-wave radar, and an estimating unit that estimates soiling of the millimeter-wave radar based on a reflected wave from the road surface reflection target received by the millimeter-wave radar when the target indicated by the information acquired by the acquisition unit is a road surface reflection target.

### CROSS-REFERENCE TO RELATED APPLICATION

This application claims priority to Japanese Patent Application No. 2025-006129 filed on January 16, 2025. The disclosure of the above-identified application, including the specification, drawings, and claims, is incorporated by reference herein in its entirety.

### BACKGROUND

### 1. Technical Field

The present disclosure relates to a soiling estimation device, a soiling estimation method, and a storage medium.

### 2. Description of Related Art

Japanese Unexamined Patent Application Publication No. 2018-179554 (JP 2018-179554 A) describes a soiling determination device for an obstruction detection sensor (radar). In technology described in JP 2018-179554 A, a count of obstructions detected by the obstruction detection sensor is used to determine whether the obstruction detection sensor is soiled.

### SUMMARY

Now, the count of obstructions detected by the obstruction detection sensor (radar) is reduced not only when the count of actual obstructions is small, but also when the obstruction detection sensor does not detect actual obstructions due to soiling of the obstruction detection sensor although the count of actual obstructions is great. Accordingly, in the technology described in JP 2018-179554 A, in order to ensure determination precision of the presence of soiling of the obstruction detection sensor, when a traveling distance satisfies at least one condition of a predetermined value or more and a steering continuation period is a predetermined value or more, and also when an undetected period of obstructions is a predetermined value or more, determination is made that the obstruction detection sensor is soiled.

That is to say, in the technology described in JP 2018-179554 A, it takes time to determine that the obstruction detection sensor is soiled, after a state in which the obstruction detection sensor is soiled. That is to say, with the technique described in JP 2018-179554 A, soiling of the obstruction detection sensor cannot be appropriately estimated.

In view of the above-described points, an object of the present disclosure is to provide a soiling estimation device, a soiling estimation method, and a storage medium, capable of appropriately estimating soiling of a millimeter-wave radar.

(1) An aspect of the present disclosure is a soiling estimation device, including an acquisition unit for acquiring information regarding a target, that is present forward of a vehicle, and that is detected by a millimeter-wave radar installed in the vehicle, a determining unit for determining whether the target indicated by the information acquired by the acquisition unit is a road surface reflection target equivalent to unevenness of a road surface forward of the vehicle that has reflected radio waves emitted from the millimeter-wave radar, and an estimating unit that, when the target indicated by the information acquired by the acquisition unit is the road surface reflection target, estimates soiling of the millimeter-wave radar, based on reflected waves from the road surface reflection target received by the millimeter-wave radar.

(2) In the soiling estimation device of (1), the estimating unit may estimate the soiling of the millimeter-wave radar, based on a count of the road surface reflection targets per unit time detected by the millimeter-wave radar during forward traveling of the vehicle.

(3) In the soiling estimation device of (1), the estimating unit may estimate the soiling of the millimeter-wave radar, based on a magnitude of reflected power per unit time indicating intensity of the radio waves emitted by the millimeter-wave radar and reflected by the road surface reflection target, and received by the millimeter-wave radar, during forward traveling of the vehicle.

(4) According to an aspect of the present disclosure, a soiling estimation method includes a soiling estimation device acquiring information regarding a target that is present forward of a vehicle detected by a millimeter-wave radar installed in the vehicle, the soiling estimation device determining whether the target indicated by the information acquired in the acquiring is a road surface reflection target equivalent to unevenness of a road surface forward of the vehicle that has reflected radio waves emitted from the millimeter-wave radar, and the soiling estimation device estimating, when the target indicated by the information acquired in the acquiring is the road surface reflection target, soiling of the millimeter-wave radar, based on reflected waves from the road surface reflection target received by the millimeter-wave radar.

(5) According to an aspect of the present disclosure, a non-transitory storage medium storing a program causes a processor to execute acquiring information regarding a target that is present forward of a vehicle detected by a millimeter-wave radar installed in the vehicle, determining whether the target indicated by the information acquired in the acquiring is a road surface reflection target equivalent to unevenness of a road surface forward of the vehicle that has reflected radio waves emitted from the millimeter-wave radar; and estimating, when the target indicated by the information acquired in the acquiring is the road surface reflection target, soiling of the millimeter-wave radar, based on reflected waves from the road surface reflection target received by the millimeter-wave radar.

According to the present disclosure, soiling of the millimeter-wave radar can be appropriately estimated.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of a vehicle 1 to which a soiling estimation device 16 according to a first embodiment is applied;

FIG. 2 is a diagram illustrating an example of a flow of data in the vehicle 1 illustrated in FIG. 1;

FIG. 3 is a diagram illustrating an exemplary relation between the number of road surface reflection targets detected by the millimeter-wave radar 11 per unit time and the amount of soiling of the millimeter-wave radar 11 estimated by the estimating unit 3C during the forward movement of the vehicle 1;

FIG. 4 is a flowchart for describing an example of processing executed by the processor 163 of the soiling estimation device 16 according to the first embodiment;

FIG. 5A is a diagram for explaining a specific embodiment of the process shown in FIG. 4;

FIG. 5B is a diagram illustrating another of a and according to an embodiment of the present disclosure in FIG. 4; and

FIG. 6 is a diagram illustrating an exemplary relation between the reflected power per unit time from the road surface reflection target detected by the millimeter-wave radar 11 during the forward movement of the vehicle 1 and the soiling level of the millimeter-wave radar 11 estimated by the estimating unit 3C.

### DETAILED DESCRIPTION OF EMBODIMENTS

Embodiments of a soiling estimation device, a soiling estimation method, and a program according to the present disclosure will be described below with reference to the drawings.

### First Embodiment

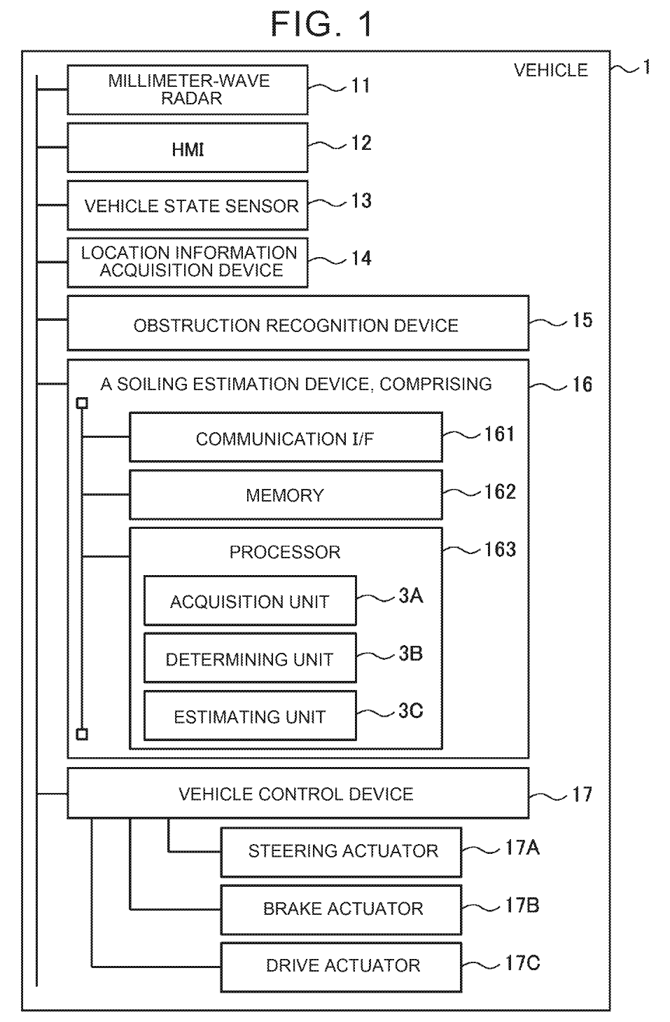

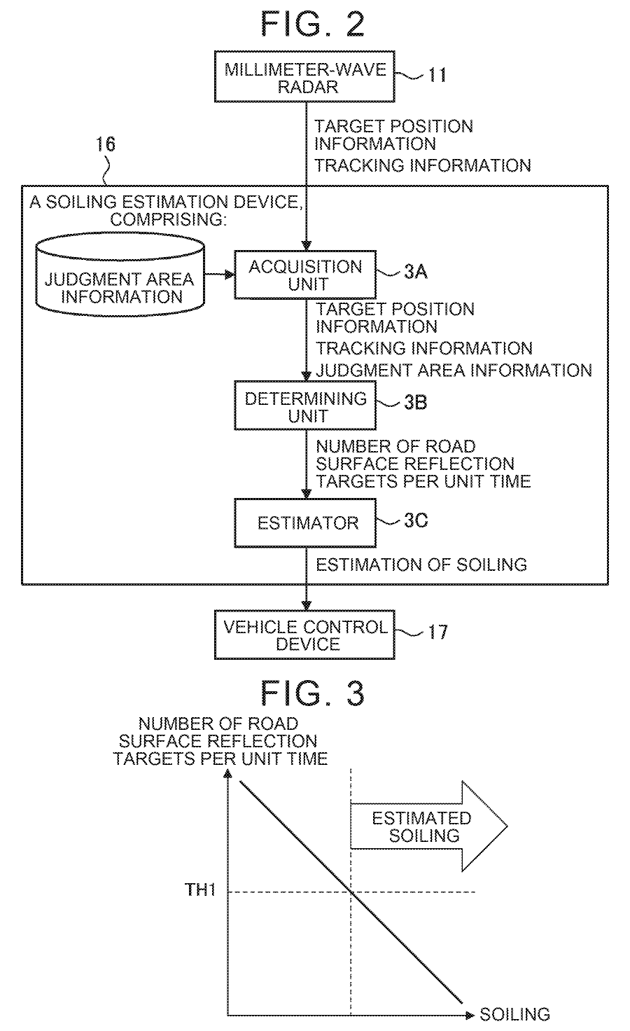

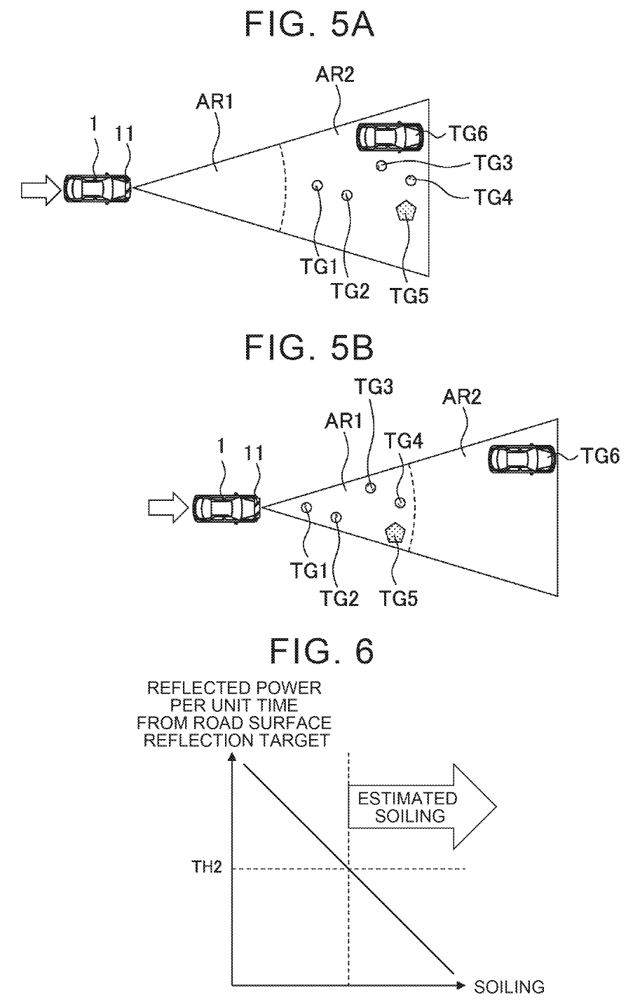

FIG. 1 is a diagram illustrating an example of a vehicle 1 to which a soiling estimation device 16 according to the first embodiment is applied. FIG. 2 is a diagram illustrating an example of a flow of data in the vehicle 1 illustrated in FIG. 1. In the embodiments illustrated in FIGS. 1 and 2, the vehicle 1 includes a millimeter-wave radar 11, an HMI (Human Machine Interface) 12, a vehicle state sensor 13, a position information acquisition device 14, an obstruction recognition device 15, a soiling estimation device 16, a vehicle control device 17, a steering actuator 17A, a braking actuator 17B, and a drive actuator 17C. The millimeter-wave radar 11 is disposed at, for example, a front portion of the vehicle 1. The millimeter-wave radar 11 detects a target TG1 to TG6 of a target object present in front of vehicle 1 (refer to FIGS. 5A and 5B), and transmits information (sensor data) related to the target object TG1 to TG6 to the obstruction recognition device 15 and the soiling estimation device 16 from the target TG1.

The inventors of the present disclosure, in intense studies, while a vehicle 1 is advancing an unpaved road, millimeter-wave radar 11 detects a large rock which the vehicle 1 needs to circumvent a collision as a TG5 (see FIGS. 5A and 5B), or detects another vehicle as a target TG6 (see FIGS. 5A and 5B). When the vehicle 1 needs to circumvent a collision, that is, when the steering actuator 17A and the braking actuator 17B need to be controlled. In addition, it has been found that the unevenness of the road surface on which the vehicle 1 does not need to circumvent the collision is detected from the target TG1 as a TG4 (refer to the FIG. 5A and the FIG. 5B) (road surface reflection target). That is, the millimeter-wave radar 11 receives radio waves (reflected waves) emitted by the millimeter-wave radar 11 and reflected by irregularities on the road surface in front of the vehicle 1. When the vehicles 1 do not need to circumvent a collision, that is, when the steering actuator 17A and the braking actuator 17B do not need to be controlled. Specifically, the unevenness of the road surface is a small unevenness of the road surface that the vehicle 1 can pass through, and the unevenness of the road surface includes, for example, a small stone. Further, although the unevenness of the road surface is detected by the millimeter-wave radar 11 as a TG4 from the target TG1 when the unevenness of the road surface is present in a first area (area in the vicinity of the vehicle 1) AR1 (refer to 5A and 5B) in which the distance from the vehicle 1 in the forward direction is an area less than a predetermined value, it is sometimes present in a second area (area far from the vehicle 1) (refer to 5A and 5B) AR2 in which the distance from the vehicle 1 in the forward direction is an area greater than or equal to a predetermined value. At this time, the present inventors have found that the millimeter-wave radar 11 does not detect a TG4 from the target TG1. Therefore, in the embodiments illustrated in FIGS. 1 and 2, measures to be described later are taken to distinguish between TG4 and the target TG5, TG6 that the vehicle 1 needs to circumvent collision from the target TG1 that the vehicle 1 does not need to circumvent collision.

In the exemplary embodiments illustrated in FIGS. 1 and 2, HMI12 has a function of accepting various operations of the user of the vehicle 1, and transmits a signal indicating the operation of the user of the vehicle 1 to the vehicle control device 17. The operation of the user of the vehicle 1 received by HMI12 includes, for example, an operation of causing the vehicle control device 17 to perform the automated driving of the vehicle 1, an operation of switching the automated driving of the vehicle 1 to the manual driving, and the like. The vehicle state sensor 13 includes, for example, a vehicle speed sensor. The vehicle state sensor 13 transmits information (for example, vehicle speed and the like) indicating the state of the vehicle 1 to the obstruction recognition device 15, the soiling estimation device 16, and the vehicle control device 17.

The position information acquisition device 14 acquires information indicating the position of the vehicle 1. The position-information acquisition device 14 includes, for example, a GPS (Global Positioning System) device that measures the position of the vehicles 1. The position information acquisition device 14 may perform a well-known self-position estimation process (localization) to increase the accuracy of information indicating the position of the vehicle 1. The position information acquisition device 14 transmits information indicating the position of the vehicle 1 to the obstruction recognition device 15, the soiling estimation device 16, and the vehicle control device 17.

The vehicle control device 17 is constituted by, for example, a vehicle control ECU (Electronic Control Unit). The vehicle control device 17 controls the steering actuator 17A, the braking actuator 17B, and the drive actuator 17C based on, for example, information (signals) transmitted from HMI12, the vehicle state sensor 13, the position information acquisition device 14, and the obstruction recognition device 15. The vehicle control device 17 has a function of executing automated driving of the vehicle 1.

The obstruction recognition device 15 acquires, from the millimeter-wave radar 11, information (specifically, time-series data) related to TG6 (refer to FIGS. 5A and 5B ) from the target TG1 existing in front of the vehicles 1 detected by the millimeter-wave radar 11. The information about TG6 from the target TG1 includes target position information (information indicating the relative position of TG6 from the target TG1 with respect to the vehicle 1) and tracking information. The tracking information is information that can distinguish whether or not TG6 are the same from the target TG1 outputted in time series from the millimeter-wave radar 11. In the examples shown in the drawings 5A and 5B, which will be described later, based on the tracking information outputted from the millimeter-wave radar 11, it can be recognized that each of the target TG5, TG6 detected by the millimeter-wave radar 11 at the previous time point shown in the FIG. 5A and each of the target TG5, TG6 detected by the millimeter-wave radar 11 at the current time point shown in the FIG. 5B are the same.

Further, the obstruction recognition device 15 determines (first determination) whether or not TG1 of the target indicates that TG6 is present in the first area AR1 (see FIG. 5B) based on the acquired information about TG6 (see FIG. 5B) from the target TG1. Further, the obstruction recognition device 15 performs determination (second determination) as to whether or not (see FIG. 5B) in the first determination is detected by the millimeter-wave radar 11 when the target TG1 to TG5 (see FIG. 5B) determined to be present in the first area AR1 is present in the second area AR2 (see FIG. 5A). The second determination is performed on the basis of the acquired target TG1 on the basis of TG6 (see the FIG. 5A and the FIG. 5B).

Further, in the first determination, it may be determined that TG1 of the target indicates that TG4 (see FIG. 5B) is present in the first area AR1 (see FIG. 5B), and in the second determination, it is determined that the millimeter-wave radar 11 does not detect the target TG1 of the target object indicates that TG4 (see FIG. 5A) is present in the second area AR2 (see FIG. 5A). Here, the obstruction recognition device 15 discards TG4 from the target TG1. Further, the obstruction recognition device 15 outputs information on the target TG5 to the vehicle control device 17 when it is determined in the first determination that the target TG5 (refer to the FIG. 5B) is present in the first area AR1 (refer to the FIG. 5B), and when it is determined in the second determination that the target TG5 (refer to the FIG. 5A) is present in the second area AR2 (refer to the FIG. 5A), it is determined that the target is detected by the millimeter-wave radar 11. The vehicle control device 17 executes control for operating the steering actuator 17A and/or the braking actuator 17B on the basis of the information regarding the target TG5 outputted from the obstruction recognition device 15 in order to circumvent a collision between the vehicle 1 and the target TG5. On the other hand, unnecessary control of actuating the steering actuator 17A and/or the braking actuator 17B in order to circumvent a collision between the vehicle 1 and the target TG1 and TG4 is not performed by the vehicle control device 17.

In the example illustrated in FIGS. 1 and 2, the soiling estimation device 16 estimates the soiling (the presence or absence of soiling, the amount of soiling, and the like) of the millimeter-wave radar 11. The soiling estimation device 16 is constituted by a microcomputer including a communication interface (I/F) 161, a memory 162, and a processor 163. The communication interface 161 includes interface circuitry for connecting the soiling estimation device 16 to the millimeter-wave radar 11, HMI12, the vehicle state sensor 13, the position information acquisition device 14, the obstruction recognition device 15, and the vehicle control device 17. The memory 162 stores programs and various types of data used in processing executed by the processor 163. The data stored in the memory 162 includes, for example, determination area information (see FIG. 2). The determination area information is information in which a parameter (for example, a size or the like) related to a first area AR1 (refer to FIGS. 5A and 5B) in which a TG4 (road surface reflection target) may exist from a target TG1 in which the vehicle 1 does not need to circumvent a collision is defined. The area in which the millimeter-wave radar 11 detects TG4 (road surface reflection target) from the target TG1 in which the vehicle 1 does not need to circumvent the collision varies depending on the condition and material of the road surface on which the vehicle 1 travels. Therefore, the parameter related to the first area AR1 is adjusted by, for example, the user of the vehicle 1 according to the usage environment of the vehicle 1. That is, the memory 162 stores, for example, determination area information adjusted by the user of the vehicle 1 or the like according to the use environment of the vehicle 1. The processor 163 has a function as an acquisition unit 3A, a function as a determining unit 3B, and a function as an estimating unit 3C.

The acquisition unit 3A acquires, from the millimeter-wave radar 11, information (specifically, time-series data) related to TG6 (refer to FIGS. 5A and 5B) from the target TG1 existing in front of the vehicle 1 detected by the millimeter-wave radar 11. As described above, the information about TG6 from the target TG1 includes target position information (information indicating the relative position of TG6 from the target TG1 with respect to the vehicle 1) and tracking information. The information about TG6 from the target TG1 also includes information indicating the strength of the reflected wave from TG6 from the target TG1 detected by the millimeter-wave radar 11.

The determining unit 3B determines whether or not TG6 (see 5B) from the target TG1 indicated by the information acquired by the acquisition unit 3A is a road surface reflection target corresponding to the unevenness of the road surface in front of the vehicle 1 that has reflected the radio waves emitted from the millimeter-wave radar 11. Specifically, the determining unit 3B performs determination (first determination of the determining unit 3B) as to whether or not the target is present in the first area AR1 (refer to FIG. 5B) based on the information on the target acquired by the acquisition unit 3A. The determining unit 3B determines whether or not the target determined to be present in the first area AR1 in the first determination is detected by the millimeter-wave radar 11 when the target is present in the second area AR2 (see FIG. 5A) based on the information on the target acquired by the acquisition unit 3A. That is, the second determination of the determining unit 3B is executed. Further, in a case where the target is present in the first area AR1, and in a case where the target determined to be present in the first area AR1 in the determining unit 3B is detected by the millimeter-wave radar 11 when the target is present in the second area AR2, the determining unit 3B determines that the target is not a road surface reflection target. On the other hand, when the target is present in the first area AR1 and the target determined to be present in the first area AR1 in the determining unit 3B is not detected by the millimeter-wave radar 11 when the target is present in the second area AR2, the determining unit 3B determines that the target is a road surface reflection target. In the FIGS. 5A and 5B described later, the determining unit 3B determines that TG4 is the road surface reflection target from the target TG1, and determines that the target TG5, TG6 is not the road surface reflection target.

When the determining unit 3B determines that the target is a road surface reflection target, the estimating unit 3C estimates the soiling of the millimeter-wave radar 11 based on the reflected wave from the road surface reflection target received by the millimeter-wave radar 11. Specifically, the estimating unit 3C estimates the soiling of the millimeter-wave radar 11 on the basis of the number of road surface reflection targets detected by the millimeter-wave radar 11 per unit time during the forward movement of the vehicle 1.

FIG. 3 is a diagram illustrating an exemplary relation between the number of road surface reflection targets detected by the millimeter-wave radar 11 per unit time during the forward movement of the vehicle 1 and the soiling quantity of the millimeter-wave radar 11 estimated by the estimating unit 3C. In the embodiment illustrated in FIG. 3, the smaller the number of road surface reflection targets detected by the millimeter-wave radar 11 per unit-time during the forward movement of the vehicle 1, the larger the soiling level of the millimeter-wave radar 11 estimated by the estimating unit 3C. Specifically, in the embodiment illustrated in FIG. 3, when the number of the road surface reflection targets detected by the millimeter-wave radar 11 per unit time during the forward movement of the vehicle 1 is less than the threshold TH1, the estimating unit 3C estimates that the millimeter-wave radar 11 is soiled.

In the exemplary embodiments illustrated in FIGS. 1 and 2, when the estimating unit 3C estimates that the millimeter-wave radar 11 is soiled, the estimating unit outputs information indicating that the millimeter-wave radar 11 is soiled to the vehicle control device 17. The vehicle control device 17 causes HMI12 to output information indicating that the millimeter-wave radar 11 is soiled, and requests the user of the vehicle 1 or the like to clean the millimeter-wave radar 11.

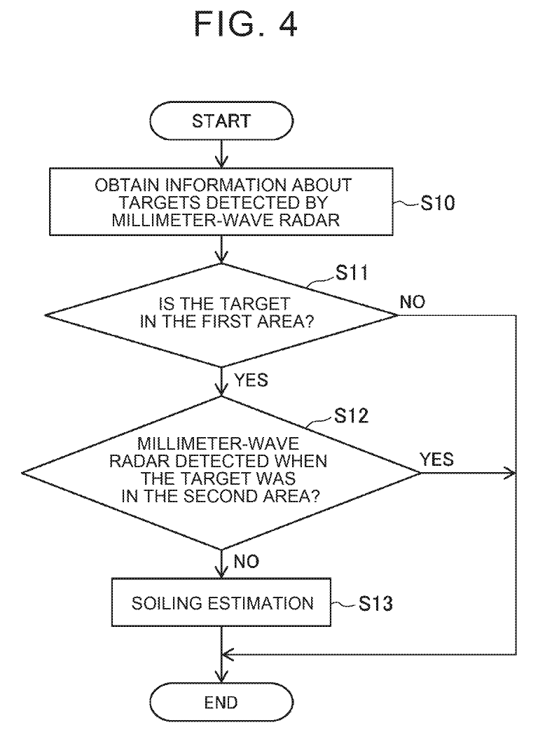

FIG. 4 is a flowchart for explaining an example of a process executed by the processor 163 of the soiling estimation device 16 according to the first embodiment. The process illustrated in FIG. 4 is executed, for example, while the vehicle 1 is traveling (specifically, while the vehicle is traveling forward).

In the exemplary embodiment illustrated in FIG. 4, in S10, the acquisition unit 3A acquires, from the millimeter-wave radar 11, information about a target present in front of the vehicles 1 detected by the millimeter-wave radar 11. In S11 and S12, the determining unit 3B determines whether or not the target indicated by the information acquired in S10 is a road surface reflection target corresponding to the unevenness of the road surface in front of the vehicle 1 that has reflected the radio waves emitted from the millimeter-wave radar 11. Specifically, in S11, the determining unit 3B determines (first determination) whether or not the target is present in the first area AR1 (see FIG. 5B) based on the information about the target acquired in S10. Specifically, the information about the target object acquired in S10 is the current data of the time-series data. In the case of YES, the process proceeds to S12, and in the case of NO, the process illustrated in FIG. 4 is ended.

In S12, the determining unit 3B determines (second determination) whether or not a target determined to be present in the first area AR1 in S11 is detected by the millimeter-wave radar 11 when the target is present in the second area AR2 (refer to FIGS. 5A) based on the information on the target acquired in S10. Specifically, the information about the target object acquired in S10 is time-series data including the current data and the data at a point in time that is earlier than the current data. In the case of YES (in the case where the target object indicated by the information acquired in S10 is not the road surface reflection target), the process illustrated in FIG. 4 is ended, and in the case of NO (in the case where the target object indicated by the information acquired in S10 is the road surface reflection target), the process proceeds to S13. In S13, the estimating unit 3C estimates the soiling of the millimeter-wave radar 11 based on the information indicating the reflected wave from the road surface reflection target acquired in S10.

FIGS. 5A and 5B are diagrams for explaining a specific embodiment of the process illustrated in FIG. 4. Specifically, FIG. 5A shows an exemplary positional relation among the vehicles 1, TG6 from the target TG1, the first area AR1, and the second area AR2 at a previous point in time. 5B shows an exemplary positional relation among the vehicles 1, TG6 from the target TG1, the first area AR1, and the second area AR2 at the present time. In the FIG. 5A and 5B, in S10 of FIG. 4, the acquisition unit 3A acquires, from the millimeter-wave radar 11, information about TG6 from the target TG1 existing in front of the vehicles 1 detected by the millimeter-wave radar 11. The information regarding the target TG1 to TG6 is, for example, information indicating the time-series data of TG6 from the target TG1 detected by the millimeter-wave radar 11 and the reflected wave from the target TG1 to TG6 detected by the millimeter-wave radar 11 from the previous time point shown in FIG. 5A to the current time point shown in FIG. 5B. In S11 of FIG. 4, the determining unit 3B determines that TG5 is present in the first area AR1 from the target TG1 based on the data of TG6 from the target TG1 detected by the millimeter-wave radar 11 at the current time point shown in FIG. 5B among the time-series data acquired in S10. It is determined that the target TG6 (other vehicles) does not exist in the first area AR1.

In addition, in the FIG. 5A and the FIG. 5B, in the step S12 of FIG. 4, it is determined that the millimeter-wave radar 11 has detected, even at the previous point in time illustrated in the FIG. 5A, the target TG5 (large rock) determined to be present in the first area AR1 at the current point in time illustrated in the FIG. 5B is present in the second area AR2. This determination is performed by the determining unit 3B based on the time series of TG6 from the target TG1 detected by the millimeter-wave radar 11 from the previous time point shown in FIG. 5A acquired in S10 to the current time point shown in FIG. 5B.

On the other hand, in the example illustrated in the FIG. 5A and the FIG. 5B, in S12 illustrated in FIG. 4, it is determined that TG4 is not detected by the millimeter-wave radar 11 at the previous time point illustrated in the FIG. 5A that exists in the second area AR2 from the target TG1 determined to exist in the first area AR1 at the current time point illustrated in the FIG. 5B. This determination is performed by the determining unit 3B based on the time series of TG6 from the target TG1 detected by the millimeter-wave radar 11 from the previous time point shown in FIG. 5A acquired in S10 to the current time point shown in FIG. 5B. That is, the determining unit 3B determines that TG4 from the target TG1 is a road surface reflection target corresponding to the unevenness of the road surface in front of the vehicle 1 that has reflected the radio waves emitted from the millimeter-wave radar 11.

Further, in the FIGS. 5A and 5B, in S13 of FIG. 4, the estimating unit 3C estimates the soiling of the millimeter-wave radar 11 based on the information indicating the reflected wave from TG4 (road surface reflection target) from the target TG1 acquired in S10. Specifically, in the examples shown in the FIG. 5A and the FIG. 5B, when the millimeter-wave radar 11 is not soiled, the information indicating the reflected wave from TG4 (road surface reflection target) is acquired from, for example, four target TG1 that are equal to or larger than the threshold TH1 (see FIG. 3) detected by the millimeter-wave radar 11 in S10. It is estimated that the millimeter-wave radar 11 is not soiled in S12. On the other hand, when the millimeter-wave radar 11 is soiled, information indicating a reflected wave from, for example, one target TG1 (road surface reflection target) that is less than the threshold TH1 detected by the millimeter-wave radar 11 in S10 is acquired. It is estimated that the millimeter-wave radar 11 is soiled in S12.

For example, a millimeter-wave radar may be used in an autonomous vehicle that travels in an environment where there are few surrounding structures such as a mine. When an existing obstruction is used as in the technique described in JP-A-2018-179554 for estimating the soiling of the millimeter-wave radar, the soiling of the millimeter-wave radar cannot be estimated appropriately (with high accuracy). This is because, for example, there are few obstructions that actually exist in an environment such as a mine. As described above, in the exemplary embodiments illustrated in FIGS. 1 to 5B, in order to estimate the soiling of the millimeter-wave radar 11, the actual obstruction (target TG5) is not used, and the reflected wave from the unevenness (TG4 from the target TG1) of the road surface in front of the vehicle 1 detected by the millimeter-wave radar 11 is used, so that the soiling of the millimeter-wave radar 11 can be estimated appropriately (with high accuracy). The unevenness of the road surface in front of the vehicle 1 is, in other words, unevenness that is always present on the unpaved road.

### Second Embodiment

The vehicle 1 to which the soiling estimation device 16 of the second embodiment is applied is configured in the same manner as the vehicle 1 to which the soiling estimation device 16 of the first embodiment described above is applied, except for the points described later.

As described above, in the vehicle 1 to which the soiling estimation device 16 of the first embodiment is applied, the estimating unit 3C estimates the soiling of the millimeter-wave radar 11. This estimation is performed on the basis of the number of road surface reflection targets detected by the millimeter-wave radar 11 per unit time during the forward movement of the vehicle 1. On the other hand, in the vehicle 1 to which the soiling estimation device 16 of the second embodiment is applied, the estimating unit 3C estimates the soiling of the millimeter-wave radar 11 based on the magnitude of the reflected power per unit-time indicating the strength of the radio waves. The radio waves are emitted by the millimeter-wave radar 11 during the forward movement of the vehicle 1, are reflected by TG4 (see FIGS. 5A and 5B) from the road surface reflection target TG1, and are received by the millimeter-wave radar 11.

FIG. 6 is a diagram illustrating an exemplary relation between the reflected power per unit time from the road surface reflection target detected by the millimeter-wave radar 11 during the forward movement of the vehicle 1 and the soiling level of the millimeter-wave radar 11 estimated by the estimating unit 3C. In the embodiment illustrated in FIG. 6, the smaller the reflected power per unit-time from the road surface reflection target detected by the millimeter-wave radar 11 during the forward movement of the vehicle 1 is, the larger the soiling level of the millimeter-wave radar 11 estimated by the estimating unit 3C is. The reflected power is in particular the mean reflected power from the road surface reflection target TG1 to TG4. Specifically, in the example illustrated in FIG. 6, when the reflected power per unit time from the road surface reflection target detected by the millimeter-wave radar 11 during the forward movement of the vehicle 1 is less than the threshold TH2, the estimating unit 3C estimates that the millimeter-wave radar 11 is soiled.

### Third embodiment

The vehicle 1 to which the soiling estimation device 16 of the third embodiment is applied is configured in the same manner as the vehicle 1 to which the soiling estimation device 16 of the first or second embodiment described above is applied, except for the points described later.

In the vehicle 1 (autonomous vehicle) to which the soiling estimation device 16 according to the first or second embodiment is applied as described above, the vehicle control device 17 executes control for operating the steering actuator 17A and/or the braking actuator 17B in order to circumvent a collision between the vehicle 1 and the target TG5. This control is executed based on the target TG5 outputted from the obstruction recognition device 15. On the other hand, in the vehicle 1 to which the soiling estimation device 16 according to the third embodiment is applied, the vehicle control device 17 causes HMI12 to output an alert indicating that an operation for circumventing a collision between the vehicle 1 and the target TG5 is required. This warning is output based on the information about the target TG5 output from the obstruction recognition device 15.

As described above, embodiments of the soiling estimation device, the soiling estimation method, and the program of the present disclosure have been described with reference to the drawings. However, the soiling estimation device, the soiling estimation method, and the program of the present disclosure are not limited to the above-described embodiments, and can be appropriately modified without departing from the spirit of the present disclosure. The configuration of each example of the above-described embodiment may be combined as appropriate. In each example of the above-described embodiment, the processing performed in the soiling estimation device 16 has been described as software processing performed by executing a program. However, the process performed by the soiling estimation device 16 may be a process performed by hardware. Alternatively, the processing performed in the soiling estimation device 16 may be a combined processing of both software and hardware. Further, a program stored in the memory 162 of the soiling estimation device 16 may be provided and distributed by being recorded in a computer-readable storage medium such as a semiconductor memory, a magnetic recording medium, an optical recording medium, or the like. The program is, in other words, a program that realizes the functions of the processor 163 of the soiling estimation device 16. The program is stored in a storage medium.

What is claimed is:

1. A soiling estimation device, comprising:
an acquisition unit for acquiring information regarding a target, that is present forward of a vehicle, and that is detected by a millimeter-wave radar installed in the vehicle;
a determining unit for determining whether the target indicated by the information acquired by the acquisition unit is a road surface reflection target equivalent to unevenness of a road surface forward of the vehicle that has reflected radio waves emitted from the millimeter-wave radar; and
an estimating unit that, when the target indicated by the information acquired by the acquisition unit is the road surface reflection target, estimates soiling of the millimeter-wave radar, based on reflected waves from the road surface reflection target received by the millimeter-wave radar.

2. The soiling estimation device according to claim 1, wherein the estimating unit estimates the soiling of the millimeter-wave radar, based on a count of the road surface reflection targets per unit time detected by the millimeter-wave radar during forward traveling of the vehicle.

3. The soiling estimation device according to claim 1, wherein the estimating unit estimates the soiling of the millimeter-wave radar, based on a magnitude of reflected power per unit time indicating intensity of the radio waves emitted by the millimeter-wave radar and reflected by the road surface reflection target, and received by the millimeter-wave radar, during forward traveling of the vehicle.

4. A soiling estimation method, comprising:
a soiling estimation device acquiring information regarding a target that is present forward of a vehicle detected by a millimeter-wave radar installed in the vehicle;
the soiling estimation device determining whether the target indicated by the information acquired in the acquiring is a road surface reflection target equivalent to unevenness of a road surface forward of the vehicle that has reflected radio waves emitted from the millimeter-wave radar; and
the soiling estimation device estimating, when the target indicated by the information acquired in the acquiring is the road surface reflection target, soiling of the millimeter-wave radar, based on reflected waves from the road surface reflection target received by the millimeter-wave radar.

5. A non-transitory storage medium storing a program that causes a processor to execute:
acquiring information regarding a target that is present forward of a vehicle detected by a millimeter-wave radar installed in the vehicle;
determining whether the target indicated by the information acquired in the acquiring is a road surface reflection target equivalent to unevenness of a road surface forward of the vehicle that has reflected radio waves emitted from the millimeter-wave radar; and
estimating, when the target indicated by the information acquired in the acquiring is the road surface reflection target, soiling of the millimeter-wave radar, based on reflected waves from the road surface reflection target received by the millimeter-wave radar.
